(19) United States
(12) Patent Application Publication
(10) Pub. No.: US 2021/0224645 A1
(43) Pub. Date: Jul. 22, 2021

(54) HIERARCHICAL CONCEPT BASED NEURAL NETWORK MODEL FOR DATA CENTER POWER USAGE EFFECTIVENESS PREDICTION

(71) Applicant: Alibaba Group Holding Limited, Grand Cayman (KY)

(72) Inventors: Zhan Li, Bellevue, WA (US); Li Chen, Hangzhou (CN); Feng Zeng, Beijing (CN); Guan Wang, Beijing (CN)

(21) Appl. No.: 17/055,524

(22) PCT Filed: May 28, 2018
(86) PCT No.: PCT/CN2018/088641

§ 371 Date: Nov. 13, 2020

(51) Int. Cl. G06N 3/08; G06N 3/04

(52) U.S. Cl. CPC G06N 3/08; G06F 1/26; G06N 3/04

(57) ABSTRACT

Systems and methods for a predicting power usage effectiveness (PUE) of a computer room with an optimized parameter using a Deep Concept Aggregation Neural Network (DCANN) algorithm based on hierarchical concept include receiving input feature parameters of a plurality of components associated with a computer room, and predicting the PUE of the computer room using a trained neural network, which comprises a hierarchical concept layer having embedded domain knowledge of the plurality of components placed between an input layer and a hidden layer.

### BACKGROUND

In a computer room of a data center, an environment control system, such as a heating, ventilation, and air conditioning (HVAC) system, is provided to maintain an acceptable operating environment for computing equipment that includes components such as servers, power supplies, displays, routers, network and communication modules, and the like, in the computer room. Based on the total energy consumed by the computer room and the total energy consumed by the computing equipment, power usage effectiveness (PUE), which may be used to assess the energy efficiency of the computer room, may be calculated.

The HVAC system may include many duplicative and/or similar components, such as coolers, fans, secondary pumps, air conditioners, refrigeration units, water pumps, and the like. For example, it is not unusual to equip more than fifty computer room air conditioning units (CRAC) in one computer room with tens of temperature and humidity sensors. A deep learning network is a well-known system, which does not distinguish various input features. It is more difficult for general deep learning model to apply to a system having a large number of duplicate and similar devices such as a computer room of a data center. Although these HVAC components have complex nonlinear correlations, the inputs from the sensors are treated equally from the perspective of a neural network structure, and information behind data from the inputs may be biased by the duplicative and/or similar inputs, which may result overfitting and eventual inaccuracy, causing inefficiency.

To avoid the duplicative and/or similar inputs and to improve the PUE of the computer room, a popular solution is to manually aggregate the inputs based on a human expert's domain knowledge, and to set the aggregated input as the input to the neural network. However, this solution is room-specific and introduces extra manual work. Further, because this solution relies on the experience and analysis of an HVAC expert, it is difficult to fully understand the most reasonable correlations among various HVAC components to achieve an energy efficient computer room condition in different operating conditions, such as outdoor temperature, outdoor humidity, computing load, and the like.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example block diagram of components of a Deep Concept Aggregation Neural Network (DCANN) that may be utilized to predict power usage effectiveness (PUE) of a computer room.

FIG. 2 illustrates an example detailed block diagram of one of the blocks of FIG. 1.

FIG. 3 illustrates an example detailed block diagram of another block of the blocks of FIG. 1.

FIG. 4 illustrates an example block diagram of layers of the DCANN.

FIG. 5 illustrates an example flowchart describing a process of predicting PUE by the DCANN.

### DETAILED DESCRIPTION

Systems and methods discussed herein are directed to predicting energy efficiency of a computer room in a data center, and more specifically to predicting power usage effectiveness (PUE) of a computer room with an optimized parameter using a Deep Concept Aggregation Neural Network (DCANN) algorithm based on hierarchical concept.

To ultimately achieve power usage effectiveness (PUE) optimization by ensuring a reasonable and appropriate operating environment, such as the environment of a computer room, and reducing waste in setting components of an environment control system, such as an HVAC system, machine learning methods may be used to learn from historical data to obtain complex relationships among various HVAC components and the energy efficiency of the computer room in different operating conditions.

In the DCANN, domain knowledge of the components associated with the HVAC system and the computing equipment of the computer room, for example, may be embedded into the neural network structure. By embedding the domain knowledge of the components into the DCANN, the number of inputs and the complexity of a search space may be reduced and the accuracy of the PUE prediction may be increased. In the DCANN, the neural network model structure may be combined with hierarchical layered concepts to embed concepts and relationships among the various components of the HVAC system and the computing equipment to solve the influence of a neural network model with a large number of redundancy and similar components as inputs. The DCANN may also enable automated aggregation of dependent data. The DCANN may embed the domain knowledge into the structure of the neural network through a type of layer called a hierarchical concept layer. The hierarchical concept layer may then be added between the input layer and the hidden layers of the neural network.

The hierarchical concept layer may be utilized to organize concepts and instances, where the concepts are abstract and the instances are concrete. The hierarchical concepts are similar to an ontology, which is a specification of a conceptualization that contains sets of concepts, instances and their relations to a domain, and provides an organized way to present vocabulary in a specific domain. For example, a temperature transmitter of a computer room air conditioning (CRAC) unit may be an instance; “CRAC transmitter” may be a concept. One “CRAC transmitter” concept may have many instances, such as CRAC transmitter 1 on CRAC 1, CRAC transmitter 2 on CRAC 1, etc. Furthermore, a concept may belong to a higher concept. For example, a concept “sensors on CRAC” may have sub-concepts such as “CRAC temperature sensor”, “CRAC humidity sensor”, and the like.

Based on the components of the HVAC system and the computing equipment, and the relationships among the components and the computer room, an association diagram of equipment concept, or a concept structure, may be constructed. Each input feature xᵢ, such as an air conditioner switch 1, may belong to an upper concept cⱼ, such as an air conditioner 1 associated with the air conditioner switch 1. The air conditioner 1, cⱼ, may belong to an upper concept aₖ, such as air conditioning. With additional layers in the hierarchical concept map, further grouping may be obtained as: cⱼ=[xᵢ₁, xᵢ₂, xᵢ₃, . . . ], aₖ=[cⱼ₁, cⱼ₂, . . . ]. A specific input parameter may then be selected to be optimized for predicting the computer room PUE.

Based on the concept structure, a neural network architecture, that reflects the deep learning of the components and their associated concepts, may be automatically generated. From the perspective of a neural network matrix, there are n input features, an input feature vector X=[x₁, x₂, . . . , xₙ], an input vector of the concept layer C=[c₁, c₂, . . . , cₘ], which is converted from the input feature vector X by matrix multiplication. The input vector of the concept layer may be multiplied by the matrix to obtain the vector of the aggregation concept layer A=[a₁, a₂, . . . , aₖ]. Next, the DCANN may be trained by using a gradient descent algorithm to implement the learning of input feature parameters for the corresponding concepts, while there may be no gradient adjustment for non-corresponding concepts.

Once trained, the DCANN may receive and use real-time data for optimizing the specific input parameter selected to predict the PUE of the computer room.

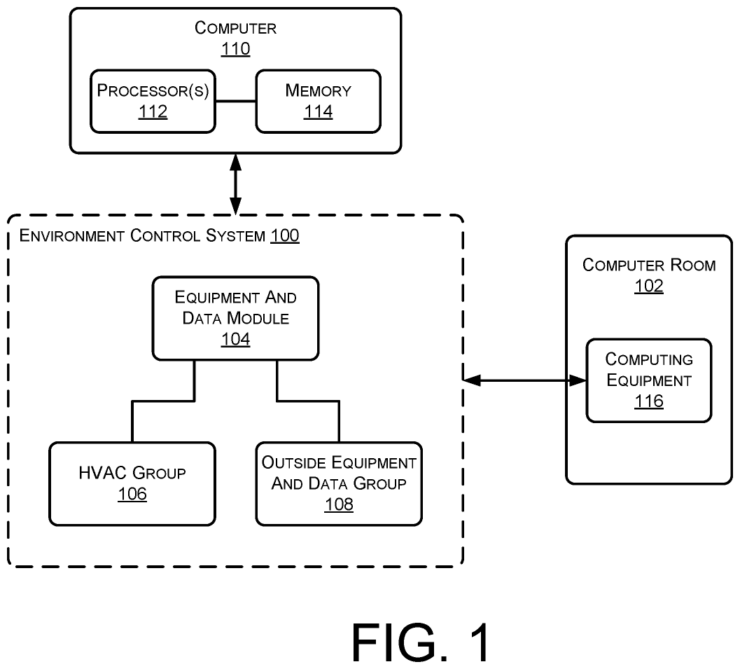

FIG. 1 illustrates an example block diagram of an environment control system 100 used with a Deep Concept Aggregation Neural Network (DCANN), which may be utilized to predict power usage effectiveness (PUE) of a computer room 102.

The environment control system 100 may include a plurality of components such as an equipment-and-data module 104 communicatively coupled to an HVAC group 106 and an outside equipment-and-data group 108. The equipment-and-data module 104 may be configured to maintain profiles of components managed by the HVAC group 106 and the outside equipment-and-data group 108, receive input data from various sensors associated with those components, and transmit data to those components to, in part, control the environment of, and calculate a predicted PUE of, the computer room 102. Some of the environment control system components may be located in the computer room 102, and other components may be located outside of a building in which the computer room 102 is located. The environment control system 100 may monitor energy consumption of components associated with the computer room 102, the equipment-and-data module 104, the HVAC group 106, and the outside equipment-and-data group 108. In addition, the environment control system 100 may be communicatively coupled to a computer 110. The computer 110 may comprise one or more processors 112 and memory 114 communicatively coupled to the one or more processors 112, which may store computer-readable instructions to be executed by the computer 110 to perform functions of the DCANN described below. The computer 110 may be located within the computer room 102, or may be remotely located from the computer room 102.

The computer room 102 may house computing equipment 116 including servers, power supplies, displays, routers, network and communication modules, and the like (not shown). The computing equipment 116 may be coupled to the environment control system 100 and may provide information regarding energy usage by the computing equipment 116 based on historical, current, and expected energy usage and computing loads for calculating the predicted PUE of the computer room 102.

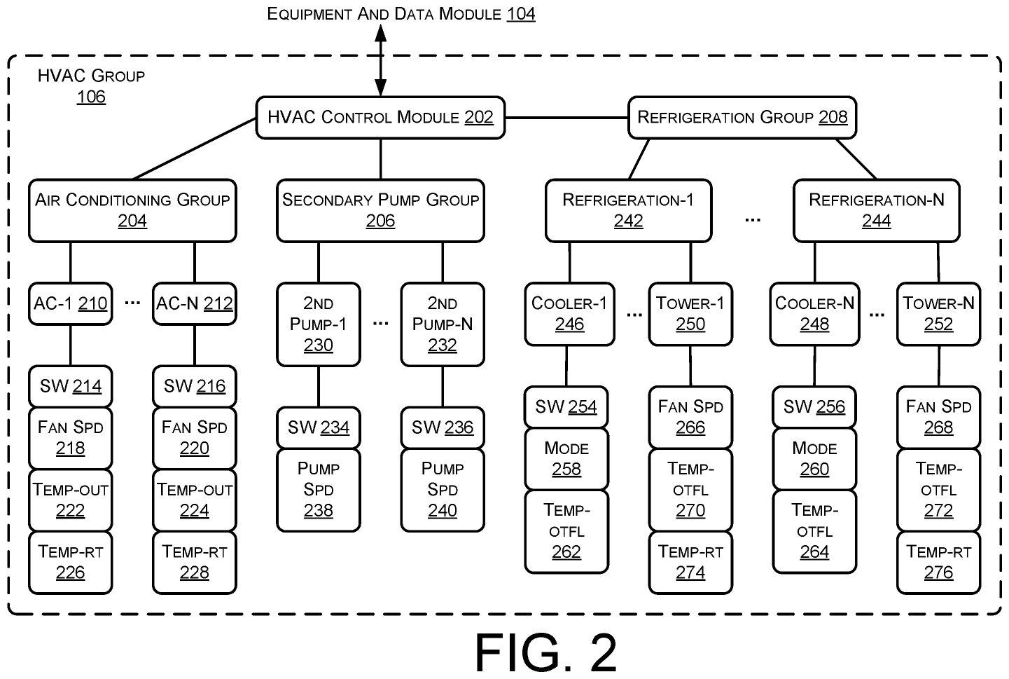

FIG. 2 illustrates an example detailed block diagram of the HVAC group 106 of FIG. 1.

The HVAC group 106 may comprise an HVAC control module 202 communicatively coupled to the equipment-and-data module 104, an air conditioning group 204, secondary pump group 206, and a refrigeration group 208. The HVAC control module 202 may be configured to receive operating information from various sensors and controllers of the air conditioning group 204, the secondary pump group 206, and the refrigeration group 208, and forward the operating information to the equipment-and-data module 104 for calculation by the DCANN. The HVAC control module 202 may also be configured to transmit control information received from the equipment-and-data module 104 to the air conditioning group 204, the secondary pump group 206, and the refrigeration group 208 for adjusting various parameters of the air conditioning group 204, the secondary pump group 206, and the refrigeration group 208 to optimize a desired parameter for predicting the PUE.

The air conditioning group 204 may comprise N air conditioners (two, AC-1 210 and AC-N 212, shown). Each of N air conditioners may comprise several controls and sensors such as a corresponding switch (two, switches 214 and 216, shown), a corresponding fan speed controller/sensor (two, fan speed controllers/sensors, fan spd 218 and 220, shown), a corresponding air conditioner output air temperature sensor (two, output temperature sensors, temp-out 222 and 224, shown), and a corresponding air conditioner return air temperature sensor (two, return temperature sensors, temp-rt 226 and 228, shown). Each of N air conditioners may be configured to receive AC operating information from the corresponding controls and sensors, and forward the AC operating information to the air conditioning system 204, which, in turn, forwards the AC operating information to the HVAC control module 202. Each of N air conditioners may also be configured to transmit AC control information received from the air conditioning system 204 to the corresponding controls to optimize a desired parameter for predicting the PUE.

The secondary pump group 206 may comprise N secondary pumps (two, 2nd pump-1 230 and 2nd pump-N 232, shown). Each of N secondary pumps may comprise several controls and sensors such as a corresponding switch (two, switches 234 and 236, shown) and a corresponding pump speed controller/sensor (two, pump speed controllers/sensors, pump spd 238 and 240, shown). Each of N secondary pumps may be configured to receive pump operating information from the corresponding controls and sensors, and forward the pump operating information to the secondary pump group 206, which, in turn, forward the pump operating information to the HVAC control module 202. Each of N secondary pumps may also be configured to transmit pump control information received from the secondary pump group 206 to the corresponding controls to optimize the desired parameter for predicting the PUE.

The refrigeration group 208 may comprise N refrigeration systems (two, refrigeration-1 242 and refrigeration-N 244, shown). Each of N refrigeration systems may comprise a corresponding cooling device (two, cooler-1 246 and cooler-N 248, shown) and a corresponding cooling tower (two, tower-1 250 and tower-N 252, shown). Each of N cooling devices may comprise a corresponding switch (two, switches 254 and 256, shown), a corresponding cooling mode controller (two, cooling mode controllers, mode 258 and 260, shown), and a corresponding outflow cooling water temperature controller/sensor (two, outflow cooling water temperature controllers/sensors, temp-otfl 262 and 264, shown). Each of N cooling tower may comprise a corresponding cooling tower fan speed controller/sensor (two, fan speed controllers/sensors, fan spd 266 and fan 268, shown), a corresponding outflow cooling water temperature controller/sensor (two, outflow cooling water temperature sensors, temp-otfl 270 and 272, shown), and a corresponding return cooling water temperature controller/sensor (two, return water cooling temperature controllers/sensors, temp-rt 274 and temp-rt 276, shown).

Each of N refrigeration systems may be configured to receive refrigeration operating information from the corresponding controls and sensors, and forward the refrigeration operating information to the refrigeration pump group 208, which, in turn, forward the refrigeration operating information to the HVAC control module 202. Each of N refrigeration systems may also be configured to transmit refrigeration control information received from the refrigeration group 208 to the corresponding controls to optimize the desired parameter for predicting the PUE.

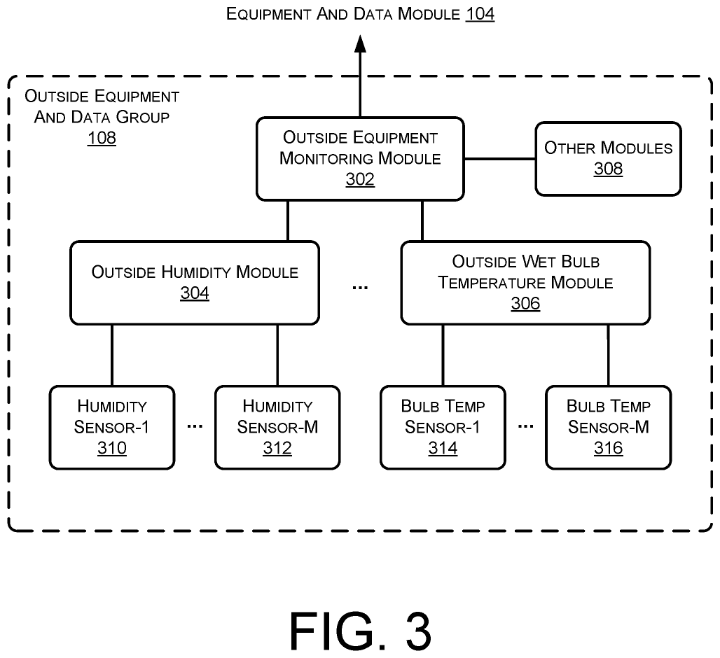

FIG. 3 illustrates an example detailed block diagram of the outside equipment and data group 108 of FIG. 1.

The outside equipment and data group 108 may comprise an outside equipment monitoring module 302 communicatively coupled to the equipment and data module 104, an outside humidity module 304, an outside wet bulb temperature module 306, and other modules 308. The outside humidity module 304 may be communicatively coupled to M humidity sensors (two humidity sensors, humidity sensor-1 310 and humidity sensor-M 312, shown). The outside wet bulb temperature module 306 may be communicatively coupled to M wet bulb temperature sensors (two wet bulb temperature sensors, bulb temperature sensor-1 314 and bulb temperature sensor-M 316, shown). The outside equipment monitoring module 302 may receive humidity and wet bulb temperature information from the corresponding sensors, and forward the information to the equipment and data module 104 for optimizing the desired parameter for predicting the PUE.

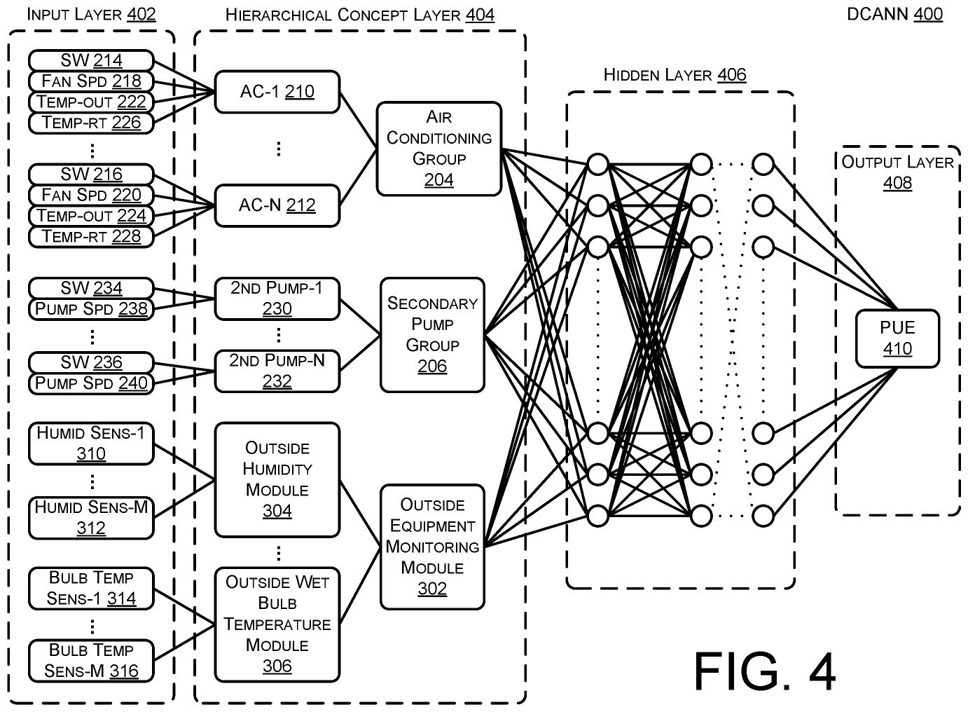

FIG. 4 illustrates an example block diagram of layers of the DCANN 400.

The DCANN 400 may comprise an input layer 402, a hierarchical concept layer 404, a hidden layer 406, and an output layer 408 as a trained neural network. The input layer 402 and the hierarchical concept layer 404 may construct a concept structure based on relationships among the plurality of components.

The input layer 402 may include a plurality of instances, and each of the plurality of instances may provide its data to a corresponding hierarchical entity in the hierarchical concept layer 404. For this example, the input layer 402 is illustrated to include the following instances with reference to FIG. 2 that are associated with corresponding concepts illustrated in the hierarchical concept layer 404: the switch 214, the fan speed controller/sensor 218, the output temperature sensor 222, and the return temperature sensors 226 associated with the air conditioner-1 210; the switch 216, the fan speed controller/sensor 220, the output temperature sensor 224, and the return temperature sensors 228 associated with the air conditioner-N 212; the switch 234 and the pump speed controller/sensor 238 associated with the secondary pump-1 230; the switch 236 and the pump speed controller/sensor 240 associated with the secondary pump-N 232; the humidity sensor-1 310 and the humidity sensor-M 312 associated with the outside humidity module 304; and the bulb temperature sensor-1 314 and the bulb temperature sensor-M 316 associated with the outside wet bulb temperature module 306.

The hierarchical concept layer 404 may organize concepts and instances similar to ontology, which contains sets of concepts and instances, and their relationships to a domain, and to present vocabulary in a specific domain in an organized way. The hierarchical concept layer 404 may organize concepts and instances illustrated in the input layer 402, and embed domain knowledge of types of equipment associated with the instances into the structure of the neural network.

The hierarchical concept layer 404 may include, in this example, 1) the air conditioning group 204 comprising N air conditioners (AC-1 210 and AC-N 212 shown), each of which may be associated with its corresponding instances of the input layer 402; 2) the secondary pump group 206 comprising N secondary pumps (the secondary pump-1 230 and the secondary pump-N 232 shown), each of which may be associated with its corresponding instances of the input layer 402; and 3) the outside equipment monitoring module 302 comprising the outside humidity module 304 which may be associated with its corresponding instances of the input layer 402, and the outside wet bulb temperature module 306 which may be associated with its corresponding instances of the input layer 402.

For example, each input feature xi illustrated in the input layer 402, such as the switch 214, may belong to an upper concept cj in the hierarchical concept layer 404, such as the air conditioner 1 210 associated with the switch 214. The air conditioner 1 210, may belong to an upper concept aₖ, such as the air conditioning group 204. With additional layers in the hierarchical concept map, further grouping may be obtained as: cⱼ=[xᵢ₁, xᵢ₂, xᵢ₃, . . . ], aₖ=[cⱼ₁, cⱼ₂, . . . ]. Based on the concept structure, a neural network architecture, that reflects the deep learning of the components and their associated concepts, may be automatically generated. From the perspective of a neural network matrix, there are n input features as illustrated in the input layer 402, an input feature vector X may be expressed as X=[x₁, x₂, . . . , xₙ] where x is a corresponding input feature parameter, and an input vector, C, of the hierarchical concept layer 404 may be expressed as C=[c₁, c₂, . . . , cₘ], where m is an integer equal to a number of the first upper concepts and c is a corresponding first upper concept. The input vector, C, of the hierarchical concept layer 404 may be converted from the input feature vector X by matrix multiplication. The input vector of the hierarchical concept layer 404 may be multiplied by the matrix to obtain the vector, A, of the aggregation concept layer, which may be expressed as A=[a₁, a₂, . . . , aₖ] where k is an integer equal to the number of the first concepts and a is an aggregated concept of a corresponding first upper concept.

The data from the instances may be forwarded to the hierarchical concept layer 404, where the data may be organized to account for duplicative and/or similar input data, and then be forwarded to the hidden layer 406. The DCANN 400 may be trained using historical data associated with the instances, i.e., historical information from the input layer 402, utilizing a gradient descent algorithm to implement the learning of input feature parameters for the corresponding concepts, while there may be no gradient adjustment for non-corresponding concepts. Once trained, the DCANN 400 may be utilized to predict a power utilization effectiveness (PUE) 410 of a desired parameter as an output in the output layer 408. The training of the DCANN 400 and the prediction utilizing the DCANN 400 may be performed separately and/or by different parties.

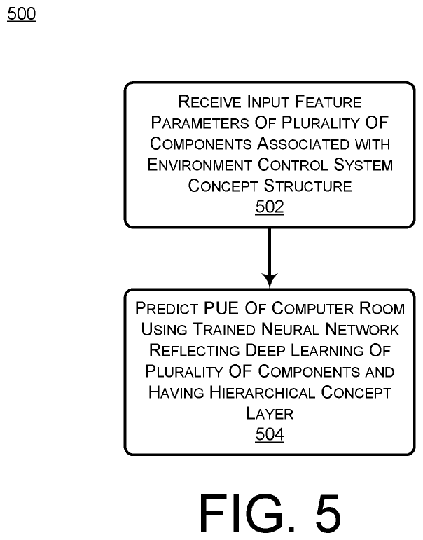

FIG. 5 illustrates an example flowchart 500 describing a process of predicting the power utilization effectiveness (PUE) by the DCANN 400.

At block 502, the DCANN 400 may receive input feature parameters of the plurality of components, such as the components associated with the environment control system 100 as discussed above with reference to FIGS. 1-3, associated with at least one computer room, such as the computer room 102. The DCANN 400 may receive the input feature parameters automatically. Each of the input feature parameters may include corresponding associated historical data. Each component of the environment control system 100 may have one or more corresponding input feature parameters with corresponding data. The relationships among components of the environment control system 100 associated with the computer room 102 may include relationships among components, such as the components illustrated in FIGS. 1-3, of the environment control system 100, and computing equipment 116 that are located in the computer room 102. The computing equipment 116 may include servers, power supplies, displays, routers, network and communication modules (telephone, internet, wireless devices, etc.), and the like. The relationships among components of the environment control system 100 and the computing equipment 116 may be based on loading of the computing equipment 116, such as a workload, or computing load, of the servers and an electrical load of the servers as a function of the workload of the servers.

The input feature parameters may comprise n input feature parameters, as shown in the input layer 402, where n is an integer. Each input feature parameter may belong to a corresponding first upper concept of a plurality of first upper concepts, and each first upper concept may belong to a corresponding second upper concept of a plurality of second upper concepts, as illustrated in the hierarchical concept layer 404. For example, as illustrated in FIG. 4, an input feature parameter may be provided by the switch 214 in the input layer 402, the switch 214 belongs a first upper concept, the air conditioner-1 210 in the hierarchical concept layer 404, and the air conditioner-1 210 belongs to a second upper concept, the air conditioning group 204 in the hierarchical concept layer 404.

An input feature vector X may be expresses as:

X=[x₁, x₂, . . . , xₙ], where n is an integer equal to the number of input features, and x is a corresponding input feature.

An input vector of the first upper concept layer C may be expressed as:

C=[c₁, c₂, . . . , cₘ], where m is an integer equal to the number of the first concepts, and c is a corresponding first upper concept. The input vector of the first upper concept layer C may be calculated by performing a matrix multiplication on the input feature vector X as shown below.

$$[ \begin{matrix}{x}_{1} & … & {x}_{n}\end{matrix} ] [ \begin{matrix}{xc}_{1}^{1} & … & {xc}_{m}^{1} \\ ⋮ & ⋱ & ⋮ \\ {xc}_{1}^{n} & … & {xc}_{m}^{n}\end{matrix} ] = [ \begin{matrix}{c}_{1} & … & {c}_{m}\end{matrix} ]$$

A vector of an aggregated concept A may be expressed as:

A=[a₁, a₂, . . . , aₖ], where k is an integer equal to the number of the first concepts, and a is an aggregated concept of a corresponding first upper concept. The vector of the aggregated concept A may be calculated by performing a matrix multiplication on the input vector of the first upper concept layer C.

At block 504, the DCANN 400 may predict a power usage effectiveness (PUE) of the computer room 102 using a trained neural network at block 504. The trained neural network may be generated automatically, and the training of the trained neural network may be performed by using a gradient descent algorithm to implement learning of the input feature parameters for corresponding concepts. An architecture of the trained neural network may reflect deep learning of the plurality of components and associated concepts based on the relationships among the plurality of components. The trained neural network may comprise a hierarchical concept layer, such as the hierarchical concept layer 404, coupled between the input layer, such as the input layer 402, and an output layer, such as the output layer 408. The hierarchical concept layer 404 may be added between the input layer 402 and the hidden layer 406 as illustrated in FIG. 4, and may be embedded with domain knowledge of the plurality of components. The hierarchical concept layer 404 may construct a concept structure based on relationships among the plurality of components. The concept structure may be created manually or automatically with smart components capable of communicating with each other. The training portion of the DCANN 400 and the prediction the PUE utilizing the DCANN 400 may be performed separately and/or by different parties.

As described above, the input feature parameters may comprise [x₁, x₂, . . . , xₙ], and if the knowledge of the deep learning network is the mapping of the input feature parameters to predict the future PUE, p, then the future PUE may be expressed as p=f(x₁, x₂, . . . , xₙ), meaning that the future PUE may be obtained based on the input feature parameters. A general deep learning network is not capable of reasonably distinguishing all duplicative and/or similar input features, and identifies the importance of each feature based entirely on historical data. In a structure, such as the computer room 102 with a large number of duplicative and similar devices, if these duplicate and/or similar input features parameters were not categorized, aggregated or abstracted, the complexity of the network and space for learning and searching would greatly increase, requiring higher quality and quantity of data. Although, it may be easy to obtain unreasonable overfitting, it would decrease prediction accuracy.

The DCANN 400 may define p=f(x₁, x₂, . . . , xₙ)−f′(xᵢ₁, xᵢ₂, x_{in′}), . . . , fₜ(xₖ₁, xₖ₂, x_{kn″}), . . . ), where the concept c₁=f₁(xᵢ₁, xᵢ₂, . . . , x_{in′}), . . . , cₜ=fₜ(xₖ₁, xₖ₂, . . . , x_{kn″}), and so on, where (xᵢ₁, xᵢ₂, . . . , x_{in′}) is a subset of (x₁, x₂, . . . , xₙ), and (xₖ₁, xₖ₂, . . . , x_{kn″}) is a subset of (x₁, x₂, . . . , xₙ). The DCANN 400 may greatly reduce the complexity of the network and solve the problems discussed above. Through the introduction of this layered concept, the search difficulty of the objective function p=f(x₁, x₂, . . . , xₙ) may be greatly reduced.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 2-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Example Clauses

A. A method for predicting power usage effectiveness (PUE) comprising: receiving input feature parameters of a plurality of components associated with at least one computer room; and predicting power usage effectiveness (PUE) of the at least one computer room using a trained neural network comprising a hierarchical concept layer coupled between an input layer and an output layer, wherein the hierarchical concept layer constructs a concept structure based on relationships among the plurality of components.

B. The method as paragraph A recites, wherein the relationships among the plurality of components include relationships among the plurality of components associated with computing equipment in the at least one computer room.

C. The method as paragraph B recites, wherein the relationships among the plurality of components are based, at least in part, on loading of the computing equipment.

D. The method as paragraph C recites, wherein the loading of the computing equipment includes a workload of the computing equipment and an electrical load used by the computing equipment.

E. The method as paragraph B recites, wherein the computing equipment includes a server and a power supply for the server.

F. The method as paragraph A recites, wherein each of the input feature parameters includes corresponding associated historical data.

G. The method as paragraph F recites, wherein: the input feature parameters comprise n input feature parameters; each input feature parameter belongs to a corresponding first upper concept of a plurality of first upper concepts; and each first upper concept belongs to a corresponding second upper concept of a plurality of second upper concepts.

H. The method as paragraph G recites, wherein: an input feature vector X=[x₁, x₂, . . . , xₙ], where n is an integer equal to a number of the input feature parameters and x is a corresponding input feature parameter; an input vector of the first upper concept layer C=[c₁, c₂, . . . , cₘ], where m is an integer equal to a number of the plurality of first upper concepts and c is a corresponding first upper concept, and the input vector of the first upper concept layer C is calculated by performing a matrix multiplication on the input feature vector X; and a vector of an aggregated concept A=[a₁, a₂, . . . , aₖ], where k is an integer equal to the number of the first concepts and a is an aggregated concept of a corresponding first upper concept, and the vector of the aggregated concept A is calculated by performing a matrix multiplication on the input vector of the first upper concept layer C.

I. The method as paragraph H recites, wherein an architecture of the trained neural network reflects deep learning of the plurality of components and associated concepts based on the relationships among the plurality of components.

J. The method as paragraph I recites, wherein the trained neural network is generated based on the concept structure by creating the hierarchical concept layer having embedded domain knowledge of the components; and adding the hierarchical concept layer between the input layer a hidden layer of the trained neural network.

K. The method as paragraph J recites, wherein training of the trained neural network is based on the input parameters by using a gradient descent algorithm to implement learning of the input feature parameters for corresponding concepts.

L. A system for predicting power usage effectiveness (PUE) comprising: one or more processors; and memory communicatively coupled to the one or more processors, the memory storing computer-readable instructions executable by one or more processors, that when executed by the one or more processors, cause the one or more processors to perform operations comprising: receiving input feature parameters of a plurality of components associated with at least one computer room; and predicting power usage effectiveness (PUE) of the at least one computer room using a trained neural network, the trained neural network comprising a hierarchical concept layer between an input layer and an output layer, wherein the hierarchical concept layer constructs a concept structure based on relationships among the plurality of components.

M. The system as paragraph L recites, wherein the relationships among the plurality of components include relationships among the plurality of components associated with computing equipment in the at least one computer room.

N. The system as paragraph M recites, wherein the relationships among the plurality of components are based, at least in part, on loading of the computing equipment.

O. The system as paragraph N recites, wherein the loading of the computing equipment includes a workload of the computing equipment and an electrical load used by the computing equipment.

P. The system as paragraph M recites, wherein the computing equipment includes a server and a power supply for the server.

Q. The system as paragraph L recites, wherein each of the input feature parameters includes corresponding associated historical data.

R. The system as paragraph Q recites, wherein: the input feature parameters comprise n input feature parameters, each input feature parameter belongs to a corresponding first upper concept of a plurality of first upper concepts, and each first upper concept belongs to a corresponding second upper concept of a plurality of second upper concepts.

S. The system as paragraph R recites, wherein: an input feature vector X=[x₁, x₂, . . . , xₙ], where n is an integer equal to a number of the input feature parameters and x is a corresponding input feature parameter; an input vector of the first upper concept layer C=[c₁, c₂, . . . , cₘ], where m is an integer equal to a number of the plurality of first upper concepts and c is a corresponding first upper concept, and the input vector of the first upper concept layer C is calculated by performing a matrix multiplication on the input feature vector X; and a vector of an aggregated concept A=[a₁, a₂, . . . , aₖ], where k is an integer equal to the number of the first concepts and a is an aggregated concept of a corresponding first upper concept, and the vector of the aggregated concept A is calculated by performing a matrix multiplication on the input vector of the first upper concept layer C.

T. The system as paragraph S recites, wherein an architecture of the trained neural network reflects deep learning of the plurality of components and associated concepts based on the relationships among the plurality of components.

U. The system as paragraph T recites, wherein the trained neural network is generated based on the concept structure by creating the hierarchical concept layer having embedded domain knowledge of the plurality of components; and adding the hierarchical concept layer between the input layer and a hidden layer of the trained neural network

V. The system as paragraph U recites, wherein training of the trained neural network is based on the input parameters by using a gradient descent algorithm to implement learning of the input feature parameters for corresponding concepts.

W. A non-transitory computer-readable storage medium storing computer-readable instructions executable by one or more processors, that when executed by the one or more processors, cause the one or more processors to perform operations comprising: receiving input feature parameters of a plurality of components associated with at least one computer room; and predicting power usage effectiveness (PUE) of the at least one computer room using a trained neural network, the trained neural network comprising a hierarchical concept layer coupled between an input layer and an output layer, wherein the hierarchical concept layer constructs a concept structure based on relationships among the plurality of components.

X. The non-transitory computer-readable storage medium as paragraph W recites, wherein the relationships among the plurality of components include relationships among the plurality of components associated with computing equipment in the at least one computer room.

Y. The non-transitory computer-readable storage medium as paragraph X recites, wherein the relationships among the plurality of components are based, at least in part, on loading of the computing equipment.

Z. The non-transitory computer-readable storage medium as paragraph Y recites, wherein the loading of the computing equipment includes a workload of the computing equipment and an electrical load used by the computing equipment.

AA. The non-transitory computer-readable storage medium as paragraph X recites, wherein the computing equipment includes a server and a power supply for the server.

AB. The non-transitory computer-readable storage medium as paragraph W recites, wherein each of the input feature parameters includes corresponding associated historical data.

AC. The non-transitory computer-readable storage medium as paragraph AB recites, wherein: the input feature parameters comprise n input feature parameters; each input feature parameter belongs to a corresponding first upper concept of a plurality of first upper concepts; and each first upper concept belongs to a corresponding second upper concept of a plurality of second upper concepts.

AD. The non-transitory computer-readable storage medium as paragraph AC recites, wherein: an input feature vector X=[x₁, x₂, . . . , xₙ], where n is an integer equal to a number of the input feature parameters and x is a corresponding input feature parameter; an input vector of the first upper concept layer C=[c₁, c₂, . . . , cₘ], where m is an integer equal to a number of the plurality of first upper concepts and c is a corresponding first upper concept and the input vector of the first upper concept layer C is calculated by performing a matrix multiplication on the input feature vector X; and a vector of an aggregated concept A=[a₁, a₂, . . . , aₖ], where k is an integer equal to the number of the first concepts and a is an aggregated concept of a corresponding first upper concept, and the vector of the aggregated concept A is calculated by performing a matrix multiplication on the input vector of the first upper concept layer C.

AE. The non-transitory computer-readable storage medium as paragraph AD recites, wherein an architecture of the trained neural network reflects deep learning of the plurality of components and associated concepts based on the relationships among the plurality of components.

AF. The non-transitory computer-readable storage medium as paragraph AE recites, wherein the trained neural network is generated based on the concept structure by: creating the hierarchical concept layer having embedded domain knowledge of the plurality of components; and adding the hierarchical concept layer between the input layer and a hidden layer of the trained neural network.

AG. The non-transitory computer-readable storage medium as paragraph AF recites, wherein training of the trained neural network based on the input parameters by using a gradient descent algorithm to implement learning of the input feature parameters for corresponding concepts.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method for predicting power usage effectiveness (PUE) comprising:
receiving input feature parameters of a plurality of components associated with at least one computer room; and
predicting the power usage effectiveness (PUE) of the at least one computer room using a trained neural network, the trained neural network comprising a hierarchical concept layer coupled between an input layer and an output layer,
wherein the hierarchical concept layer constructs a concept structure based on relationships among the plurality of components.

2. The method of claim 1, wherein the relationships among the plurality of components include relationships among the plurality of components associated with computing equipment in the at least one computer room.

3. The method of claim 2, wherein the relationships among the plurality of components are based, at least in part, on loading of the computing equipment.

4. The method of claim 3, wherein the loading of the computing equipment includes a workload of the computing equipment and an electrical load used by the computing equipment.

5. The method of claim 2, wherein the computing equipment includes a server and a power supply for the server.

6. The method of claim 1, wherein each of the input feature parameters includes corresponding associated historical data.

7.-11. (canceled)

12. A system for predicting power usage effectiveness (PUE) comprising:
one or more processors; and
memory communicatively coupled to the one or more processors, the memory storing computer-readable instructions executable by one or more processors, that when executed by the one or more processors, cause the one or more processors to perform operations comprising:
receiving input feature parameters of a plurality of components associated with at least one computer room; and
predicting the power usage effectiveness (PUE) of the at least one computer room using a trained neural network, the trained neural network comprising a hierarchical concept layer between an input layer and an output layer,
wherein the hierarchical concept layer constructs a concept structure based on relationships among the plurality of components.

13. The system of claim 12, wherein the relationships among the plurality of components include relationships among the plurality of components associated with computing equipment in the at least one computer room.

14. The system of claim 13, wherein the relationships among the plurality of components are based, at least in part, on loading of the computing equipment.

15. The system of claim 14, wherein the loading of the computing equipment includes a workload of the computing equipment and an electrical load used by the computing equipment.

16. The system of claim 13, wherein the computing equipment includes a server and a power supply for the server.

17. The system of claim 12, wherein each of the input feature parameters includes corresponding associated historical data.

18. The system of claim 17, wherein:
the input feature parameters comprise n input feature parameters,
each input feature parameter belongs to a corresponding first upper concept of a plurality of first upper concepts, and
each first upper concept belongs to a corresponding second upper concept of a plurality of second upper concepts.

19.-22. (canceled)

23. A non-transitory computer-readable storage medium storing computer-readable instructions executable by one or more processors, that when executed by the one or more processors, cause the one or more processors to perform operations comprising:
receiving input feature parameters of a plurality of components associated with at least one computer room; and
predicting power usage effectiveness (PUE) of the at least one computer room using a trained neural network, the trained neural network comprising a hierarchical concept layer coupled between an input layer and an output layer,
wherein the hierarchical concept layer constructs a concept structure based on relationships among the plurality of components.

24. The non-transitory computer-readable storage medium of claim 23, wherein the relationships among the plurality of components include relationships among the plurality of components associated with computing equipment in the at least one computer room.

25. The non-transitory computer-readable storage medium of claim 24, wherein the relationships among the plurality of components are based, at least in part, on loading of the computing equipment.

26. The non-transitory computer-readable storage medium of claim 25, wherein the loading of the computing equipment includes a workload of the computing equipment and an electrical load used by the computing equipment.

27. The non-transitory computer-readable storage medium of claim 24, wherein the computing equipment includes a server and a power supply for the server.

28. The non-transitory computer-readable storage medium of claim 23, wherein each of the input feature parameters includes corresponding associated historical data.

29. The non-transitory computer-readable storage medium of claim 28, wherein:
the input feature parameters comprise n input feature parameters,
each input feature parameter belongs to a corresponding first upper concept of a plurality of first upper concepts, and
each first upper concept belongs to a corresponding second upper concept of a plurality of second upper concepts.

30.-33. (canceled)
